(19) United States
(12) Patent Application Publication
(10) Pub. No.: US 2026/0012391 A1
(43) Pub. Date: Jan. 8, 2026

(54) SYSTEM AND METHOD FOR UPGRADATION OF ENB/GNB SOFTWARE PACKAGE

(71) Applicant: JIO PLATFORMS LIMITED, Ahmedabad, Gujarat (IN)

(72) Inventors: Aayush BHATNAGAR, Navi Mumbai, Maharashtra (IN); Pradeep Kumar BHATNAGAR, Navi Mumbai, Maharashtra (IN); Virag PATEL, Ahamedabad, Gujarat (IN); Uday SHANBHAG, Mumbai, Maharashtra (IN); Rishi KOUL, New Delhi (IN); Vivek PATEL, Indore, Madhya Pradesh (IN); Mukesh KUMAR, Delhi (IN); Chaitanya Reddy POLSONI, Navi Mumbai, Maharashtra (IN)

(73) Assignee: JIO PLATFORMS LIMITED, Ahmedabad, Gujarat (IN)

(21) Appl. No.: 18/992,897

(22) PCT Filed: May 31, 2024
(86) PCT No.: PCT/IN2024/050653

§ 371 Date: Jan. 9, 2025

(30) Foreign Application Priority Data
Jun. 29, 2023 (IN) 202321043827

(51) Int. Cl. H04L 41/082; G06F 8/65

(52) U.S. Cl. CPC H04L 41/082; G06F 8/65

(57) ABSTRACT

The disclosed system and method for modifying a software in plurality of network nodes is described. The method comprising determining, by a process engine, a process for modifying the software of a network node. The process comprises a pre-check and firmware modification, software download, and software modification and post-check. A package comprising a set of instructions, package version information, release version information, program identities associated with the release information, and a software modification schedule information is generated by a packaging unit. The process engine communicates the process to a service engine. The service engine executes the software package based on the process and modifies a schedule for at least one network node of the plurality of network nodes.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to wireless communications, and specifically to a system and a method for upgradation of Evolved NodeB (eNB)/Next Generation NodeB (gNB) software package.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Typically, a software vendor releases a new software (SW) package for example, 4 to 5 times in a year, and an engineer is required to upgrade the installed SW with the new SW packages. Currently, the upgrade is performed manually on more than 4 lakh Radio Access Network (RAN) nodes and is a tedious repetitive job leading to an occurrence of manual errors while consuming excessive time and resources.

There is, therefore, a need in the art for an improved mechanism to streamline the complete SW package upgrade process on all the RAN Nodes while reducing the occurrence of manual error along with a reduction in completion time.

### SUMMARY

In an exemplary embodiment, a method for modifying a software in plurality of network nodes is described. The method comprises determining, by a process engine, a process for modifying the software of a network node. The method comprises generating, by a packaging unit, a package comprising a set of instructions, package version information, release version information, program identities associated with the release information, and a software modification schedule information. The method comprises communicating, by the process engine, the process to a service engine. The method further comprises executing, by the service engine, the software package based on the process, and modifying schedule for at least one network node of the plurality of network nodes.

In some embodiment, the process comprises a pre-check and firmware modification, software download, and software modification and post-check.

In some embodiment, the method comprises performing the pre-check and firmware modification on the node based on the process. For the pre-check, method comprises performing an alarm check and a memory check until a plurality of commands is executed and executing pre-check commands for maintaining a log in the pre-checking. The method comprises performing firmware download and firmware upgrade for at least one network node.

In some embodiment, for the software download, the method comprises downloading the software for the network nodes based on the package version information and the release version information.

In some embodiment, the method comprises performing the software modification based on the process. The software modification comprises one of software upgrade, software updating, a hotfix, and security update.

In some embodiment, for performing the software modification and post-check the method comprises triggering the network nodes with software download success for a reboot timer change. The method comprises executing a plurality of commands for changing reboot timer parameters for the network nodes. The method comprises modifying the software for the network nodes with respect to a provided package version and release version and performing rebooting of the site from the plurality of sites.

In another exemplary embodiment, a system for modifying a software in plurality of network nodes is described. A process engine configured to determine a process for modifying the software of a network node. A packaging unit configured to generate a package comprising a set of instructions, package version information, release version information, program identities associated with the release information, and a software modification schedule information. The process engine configured to communicate the process to a service engine and the service engine configured to execute the software package based on the process and modifying schedule for at least one network node of the plurality of network nodes.

In some embodiment, the process comprises a pre-check and firmware modification, software download, and software modification and post-check.

In some embodiment, system configured to perform the pre-check and firmware modification on the node based on the process. For the pre-check, the process engine configured to perform an alarm check and a memory check until a plurality of commands is executed and execute pre-check commands for maintaining a log in the pre-checking. The process engine configured to perform firmware download and firmware upgrade for at least one network node.

In some embodiment, for the software download, the process engine configured to download the software for the network nodes based on the package version information and the release version information.

In some embodiment, the system configured to perform the software modification based on the process. The software modification comprises one of software upgrade, software updating, a hotfix, and security update.

In some embodiment, for performing the software modification and post-check, the process engine configured to trigger the network nodes with software download success for a reboot timer change and execute a plurality of commands for changing reboot timer parameters for the network nodes. The process engine configured to modify the software for a network node with respect to a provided package version and release version and perform rebooting of the site from the plurality of sites.

### OBJECTS OF THE PRESENT DISCLOSURE

It is an object of the present disclosure to perform upgradation of Evolved NodeB (eNB)/Next Generation NodeB (gNB) software package.

It is an object of the present disclosure to support Application Programming Interface (API)/Secure Shell (SSH) based execution of plurality of commands and provide dynamic load balancing.

It is an object of the present disclosure to provide a highly available upgradation system having a common execution engine.

It is an object of the present disclosure to provide an easily transformable update command sequence/syntax.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1A illustrates a modular architecture of system for a software (SW) upgrade package, in accordance with an embodiment of the present disclosure.

FIG. 1B illustrates the system for the software (SW) upgrade package, in accordance with an embodiment of the present disclosure.

FIG. 2A illustrates a software upgrade execution flow, in accordance with an embodiment of the present disclosure.

FIG. 2B illustrates pre-checks and firmware (FW) upgrade stage of the software upgrade execution flow, in accordance with an embodiment of the present disclosure.

FIG. 2C illustrates software download stage of the software upgrade execution flow, in accordance with an embodiment of the present disclosure.

FIG. 2D illustrates software upgrade and post checks stage of the software upgrade execution flow, in accordance with an embodiment of the present disclosure.

FIG. 3 illustrates an exemplary User Interface (UI) showing a path for each of the recipe creation, software upgrade to Work Order (WO) creation, and the SW upgrade WO listing, in accordance with an embodiment of the disclosure.

FIG. 4 illustrates an exemplary computer system in which or with which embodiments of the present disclosure may be implemented.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When the process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The disclosed system and method facilitate upgrading an Evolved NodeB (eNB) Software (SW) leading to streamlining of a software upgradation process and reducing occurrence of human error and reducing execution completion time of complete SW Package (PKG) upgrade on all types of Radio Access Network (RAN) Nodes. Although, the disclosure uses the example of eNB, one should appreciate that the present disclosure is applicable to nodes of all generations including 2G, 3G, 4G, 5G, 6G and beyond, of mobile technology with multiple bands and carriers of telecom operators.

An implementation strategy is developed for upgradation of the eNB SW. First, a recipe builder is used to create a recipe for each newly introduced eNB SW package. The created recipe includes details of all execution steps along with associated commands, and Application Programming Interface (API). The created recipe is then passed on to a micro service engine. Next, a user creates a software package upgrade Work Order (WO) comprising version details of both current SW Package (PKG) and a new SW PKG. In addition, the WO contains a list of service access point identifiers (SAP IDs) with execution schedule details. The list of SAP IDs may be used to find the node on which actions need to be taken for the SW Package upgrade and when to start action on the node. Further, a microservice auto triggers execution based on information related to created recipe steps, site details, execution schedule time, and the like. During the execution and after completion of the execution, a micro service engine sends execution results to a SW upgrade WO creation module. The SW upgrade WO creation module may contain a user input request containing node details, execution start date and time, etc.

The disclosed software upgrade package supports Application Programming Interface (API)/Secure Shell (SSH) execution and provides dynamic load balancing. The upgrade package provides easy to change/update command sequence/syntax.

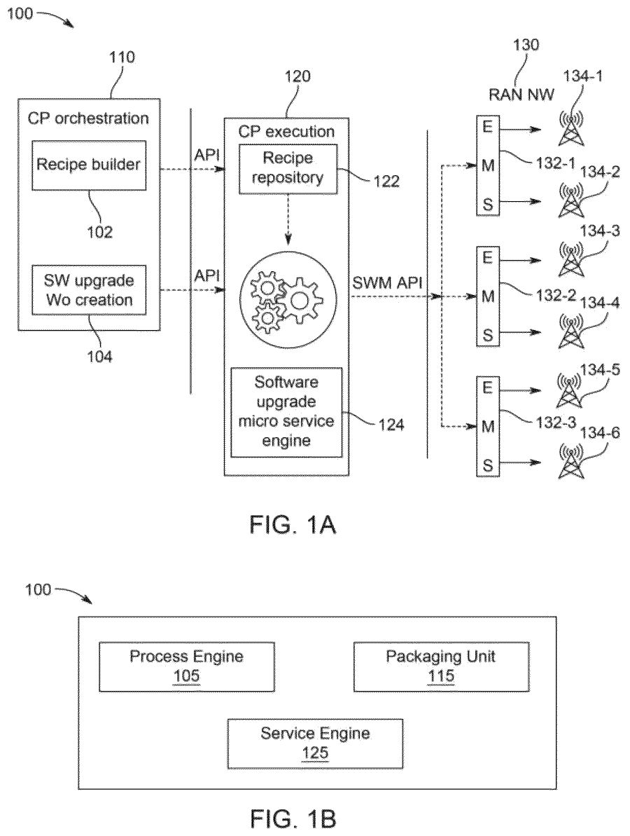

FIG. 1A illustrates a modular architecture of a system (100) for the software upgrade package, in accordance with an embodiment of the present disclosure.

As illustrated, at an orchestration level (110), a recipe builder module (102) and a software upgrade workorder (WO) creation module (104) are provided. At an execution level (120), a recipe repository (122) and a software upgrade micro service engine (124) are provided. At a random-access network (RAN) level (130), a plurality of element management systems (EMSs) (132-1, 132-2, 132-3 . . . 132-N.) is configured to manage and transmit information corresponding to a plurality of random-access network (RAN) nodes (134-1, 134-2, 134-3, 134-4, 134-5, 134-6) to the software upgrade micro service engine (124). Each of the plurality of RAN NW nodes may include two SW PKG. One SW PKG is active, and another SW PKG is passive. The passive SW PKG is a backup package. In an aspect, initially, a new software package (SW PKG) may reside in the EMS system. The software download action may start to download the SWPKG from EMS to the RAN node.

The recipe builder module (102) configured to create a plurality of recipes (e.g., newly introduced eNB software package, alarms, software upgrade, security update, etc). The recipe is sequence of commands to be executed. The recipe comprises all execution steps with associated commands and application programming interface (API) details. The created recipes are sent over an API to a recipe repository (122). The recipe repository (122) is configured to store the received recipes from the recipe builder (102), The SW upgrade WO creation (104) configured to send created workorders to a software upgrade micro service engine (124) via the API.

On receiving an API request (e.g., upgradation request, fault alarm, memory checking, etc.) from one of the nodes (e.g., node (134-1)), the EMS (132-1) corresponding to the node (134-1) configured to send the request to the software upgrade micro service engine (124) via a software management (SWM) API. The software upgrade micro service engine (124) may fetch the recipe corresponding to the request from the recipe repository (122). The fetched recipe is executed by the software upgrade micro service engine (124).

Further, each of the RAN NW nodes and the EMSs are of different original equipment manufacturers (OEMs). Because of the different OEMs, the commands for each of RAN NW nodes and the EMSs are different. The commands for each of the RAN NW nodes and the EMSs are obtained from a vendor library. The vendor library comprises command syntax, identifiers, and parameters.

In an aspect, the original equipment manufacturer (OEM) is responsible for the design, production, and often the testing of these products.

FIG. 1B illustrates the system (100) for the software (SW) upgrade package, in accordance with an embodiment of the present disclosure. The system (100) comprises a process engine (105), a packaging unit (115), and a service engine (125).

The process engine (105) is configured to determine a process for modifying the software of a network node. The process may comprise a pre-check and firmware modification, software download, and software modification and post-check. The packaging unit (115) is configured to generate a package. The package comprises a set of instructions, package version information, release version information, program identities associated with the release information, and software modification schedule information.

The process engine (105) is configured to communicate the process to a service engine (125). The service engine (125) is configured to execute the software package based on the process and modifying schedule for at least one network node of the plurality of network nodes. The schedule modification includes modifying program schedules to include a time period for executing the software package based on the process.

The process engine (105) is configured to perform the pre-check and firmware modification on the node based on the process. The process engine (105) is configured to perform an alarm check and a unified management platform (UMP) memory check during pre-checks until a plurality of commands is executed. Alarms may receive from the EMS specific to node or from a fault management system (FMS). Alarm check may refer to steps for verifying and monitoring alarms within a system or network. The alarm may be used to alert operators or administrators about abnormal conditions, faults, or failures in the nodes/sites. The alarm check may include alarm configuration, alarm monitoring, alarm verification, alarm resolution, and alarm reporting.

The process engine (105) is configured to execute pre-check commands for maintaining a log in the pre-checking and perform firmware download and firmware modification for at least one network node. The firmware modification is performed for network nodes having no alarms and having the UMP with used memory less than a predefined percentage.

During software downloading, the process engine (105) is configured to identify network nodes with the firmware upgrade success for a delete passive package (e.g., a backup package) for the network nodes. The process engine (105) is configured to trigger the network nodes with a removed backup package for the software download. The software is downloaded for the network nodes based on the package version information and the release version information. The software modification comprises one software upgrade, software updating, a hotfix, and a security update.

In an aspect, the software update is typically a release containing enhancements to the current version. The software upgrade is a whole new version of software that represents a significant change or major improvement. The hotfix is a quick correction to address a bug or defect and typically bypasses the normal software development process. The security update is, for example, geared towards improving security and fixing bugs.

The process engine (105) is configured to trigger the network nodes with software download success for a reboot timer change while performing the software modification and post-check. The process engine (105) is configured to execute a plurality of commands for changing reboot timer parameters for the network nodes. The execution is performed for the network nodes with the reboot timer change success and having memory less than a defined threshold for a software modification. The software is modified for a network node with respect to a provided package version and release version. Rebooting of the site from a plurality of sites is performed.

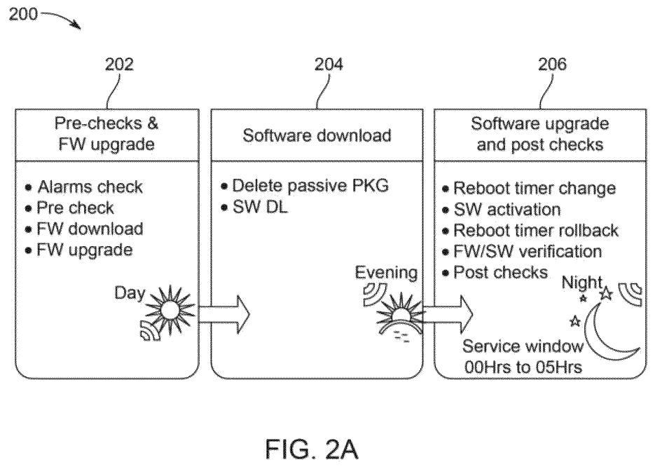

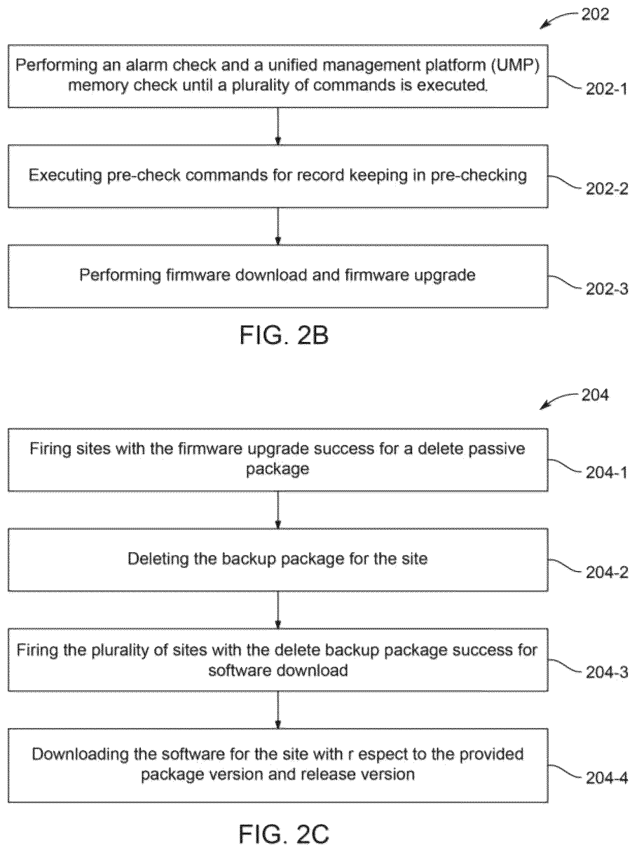

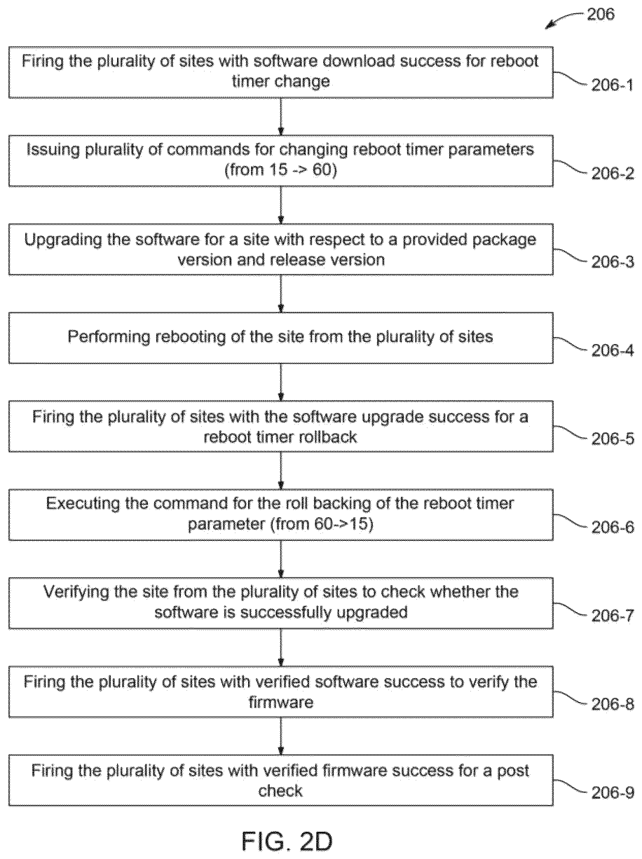

FIG. 2A illustrates a software upgrade execution flow (200), in accordance with an embodiment of the present disclosure. As is illustrated, at pre-checks and Firmware (FW) upgrade stage (202), an alarm check and a Unified Management Platform (UMP) memory check are performed until commands are executed. Further, a pre-check is performed by executing pre-check commands for record keeping. During pre-check various aspects of sites/nodes may be performed. For example, compatibility checks, prerequisites, system health, data integrity and backup are checked. Next, firmware downloads and upgrades are performed. Here sites with no alarms and having the UMP with used memory less than a predefined percentage (for example, 80%) shall be initiated for the firmware upgrade. In this stage, the firmware download/upgrade is performed for a site with respect to the package version and provided release version.

Next, at a software download stage (204), sites with the firmware upgrade success shall be fired for a delete passive package. In this stage, the backup package is deleted for a site. Further, the sites with the delete backup package success may be fired for software download. In this stage, the software is downloaded for a site with respect to the provided package version and release version.

At a software upgrade and post checks stage (206), sites with software download success may be fired for reboot timer change. In this stage, the commands are issued for changing reboot timer parameters (from 15->60), and memory until the commands are executed. In an aspect, the reboot timer parameter is used to auto reboot the node if the node is non-responsive.

In an aspect, the prechecks comprises precautionary measures before SW package upgrade RAN node configuration details. The post checks may comprise setting of RAN node configuration commands such as IP configuration, RRH configuration, cell configuration.

Thereafter, the sites with the reboot timer change success and having memory less than 80% shall be fired for the software upgrade. In this stage, the software is upgraded for a site with respect to a provided package version and release version. This also includes rebooting of the site. Next, the sites with the software upgrade success may be fired for a reboot timer rollback. In this stage, the command for the roll backing of the reboot timer parameter (from 60->15) may be executed. In addition, the sites with the reboot timer rollback success may be fired to verify the upgraded software. In this stage, the site may be verified to check whether the software is successfully upgraded or not. Also, the sites with verified software success may be fired to verify the firmware. In this stage, the site is verified to check whether the firmware is successfully upgraded or not. Finally, the sites with verified firmware success may be fired for a post check. The stage (206) occurs mostly post midnight when the telecom traffic and usage is low.

FIG. 2B illustrates pre-checks and firmware (FW) upgrade stage (202) of the software upgrade execution flow (200), in accordance with an embodiment of the present disclosure.

At step 202-1, performing an alarm check and a unified management platform (UMP) memory check until a plurality of commands is executed.

At step 202-2, executing pre-check commands for record keeping in pre-checking.

At step 202-3, performing firmware download and firmware upgrade.

FIG. 2C illustrates software download stage (204) of the software upgrade execution flow (200), in accordance with an embodiment of the present disclosure.

At step 204-1, firing sites with the firmware upgrade success for a delete passive package.

At step 204-2, deleting the backup package for the site.

At step 204-3, firing the plurality of sites with the delete backup package success for software download.

At step 204-4, downloading the software for the site with respect to the provided package version and release version.

FIG. 2D illustrates software upgrade and post checks stage (206) of the software upgrade execution flow (200), in accordance with an embodiment of the present disclosure.

At step 206-1, firing the plurality of sites with software download success for reboot timer change.

At step 206-2, issuing plurality of commands for changing reboot timer parameters (from 15->60).

At step 206-3, upgrading the software for a site with respect to a provided package version and release version.

At step 206-4, performing rebooting of the site from the plurality of sites.

At step 206-5, firing the plurality of sites with the software upgrade success for a reboot timer rollback.

At step 206-6, executing the command for the roll backing of the reboot timer parameter (from 60->15).

At step 206-7, verifying the site from the plurality of sites to check whether the software is successfully upgraded.

At step 206-8, firing the plurality of sites with verified software success to verify the firmware.

At step 206-9, firing the plurality of sites with verified firmware success for a post check.

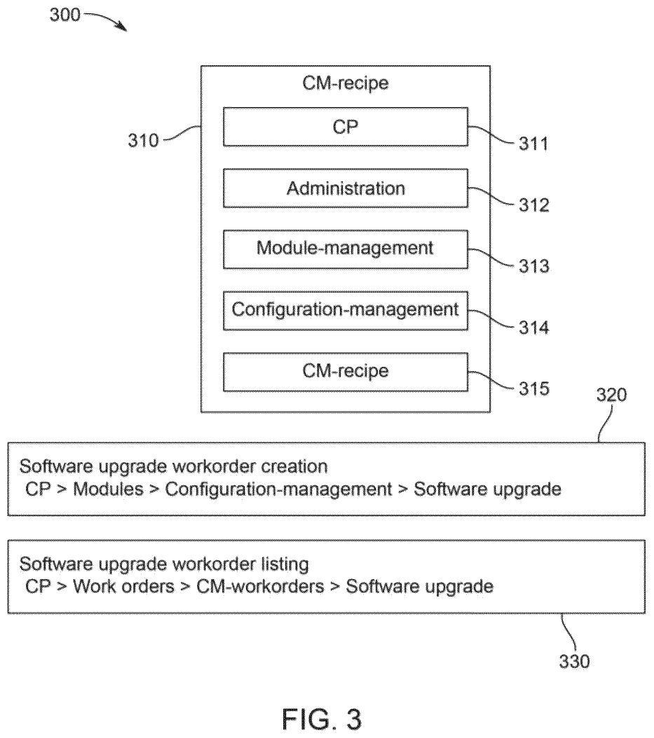

FIG. 3 illustrates an exemplary User Interface (UI) (300) showing a path for each of the recipe creation, the SW upgrade to the WO creation, and the SW upgrade WO listing, in accordance with an embodiment of the disclosure. As is illustrated, the configuration-management (CM) recipe (310) is represented as:
Creation path (CP) (311)>administration (312)>module-management (313)>configuration-management (314)>CM-recipe (315).

Similarly, the SW upgrade to WO creation (320) may be represented by:
CP (311)>modules (313)>configuration-management (314)>software upgrade

Also, the SW upgrade WO listing (330) is represented as:
CP (311)>work orders>CM-Workouts>software-upgrade

The disclosed system and method facilitate the ease of working of Network Operator Center (NOC) engineering team that had to previously deploy multiple engineers to manually perform the software upgradation tasks. The engineers had to follow the same set of instructions every time due to the repetitive nature of the upgradation task. Further, manual execution of the software upgradation task was complex as a repetitive procedure had to be followed to execute upgradation of the RAN nodes SW leading to multiple human errors. The disclosed system and method facilitate to automatically apply the software upgradation task for all the RAN nodes in a minimum stipulated time period, with zero manual error.

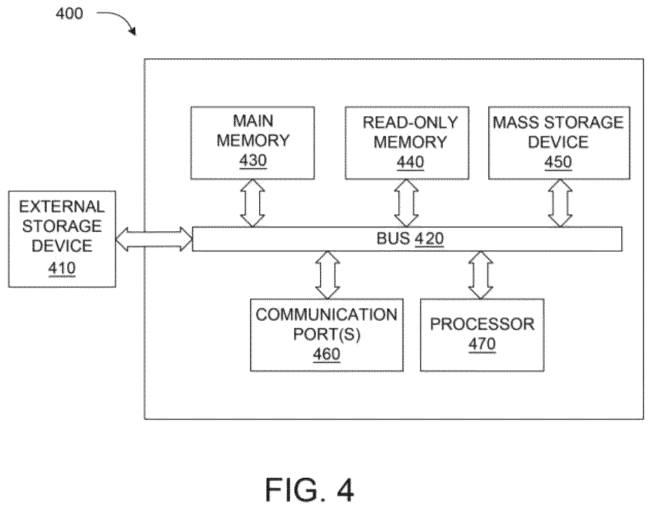

FIG. 4 illustrates an exemplary computer system 400 in which or with which embodiments of the present disclosure may be implemented. As shown in FIG. 4, the computer system 400 may include an external storage device 410, a bus 420, a main memory 430, a read-only memory 440, a mass storage device 450, communication port(s) 460, and a processor 470. A person skilled in the art will appreciate that the computer system 400 may include more than one processor and communication ports. The processor 470 may include various modules associated with embodiments of the present disclosure. The communication port(s) 460 may be any of an RS-232 port for use with a modem-based dialup connection, a 10/100

Ethernet port, a Gigabit or 10 Gigabit port using copper or fiber, a serial port, a parallel port, or other existing or future ports. The communication port(s) 460 may be chosen depending on a network, such a Local Area Network (LAN), Wide Area Network (WAN), or any network to which the computer system 400 connects.

The main memory 430 may be random access memory (RAM), or any other dynamic storage device commonly known in the art. The read-only memory 440 may be any static storage device(s) e.g., but not limited to, a Programmable Read Only Memory (PROM) chips for storing static information e.g., start-up or Basic Input/Output System (BIOS) instructions for the processor 470. The mass storage device 450 may be any current or future mass storage solution, which can be used to store information and/or instructions. Exemplary mass storage device 450 includes, but is not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g. an array of disks.

The bus 420 communicatively couples the processor 470 with the other memory, storage, and communication blocks. The bus 420 may be, e.g. a Peripheral Component Interconnect (PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor 470 to the computer system 400.

Optionally, operator and administrative interfaces, e.g. a display, keyboard, joystick, and a cursor control device, may also be coupled to the bus 420 to support direct operator interaction with the computer system 400. Other operator and administrative interfaces can be provided through network connections connected through the communication port(s) 460. Components described above are meant only to exemplify various possibilities. In no way should the aforementioned exemplary computer system 400 limit the scope of the present disclosure.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT DISCLOSURE

The present disclosure facilitates to perform upgradation of Evolved NodeB (eNB)/Next Generation NodeB (gNB) software package.

The present disclosure supports Application Programming Interface (API)/Secure Shell (SSH) based execution of plurality of commands and provides dynamic load balancing.

The present disclosure provides a highly available upgradation system having a common execution engine.

The present disclosure provides an easily transformable update command sequence/syntax.

1. A method for modifying a software of plurality of network nodes, the method comprising:
determining, by a process engine (105), a process for modifying the software of a network node;
generating, by a packaging unit (115), a package comprising a set of instructions, package version information, release version information, program identities associated with the release version information, and a software modification schedule information;
communicating, by the process engine (105), the process to a service engine (125);
executing, by the service engine (125), the package based on the process; and
modifying, by the service engine (125), schedule for at least one network node of the plurality of network nodes.

2. The method as claimed in claim 1, wherein the process comprises a pre-check and firmware modification, a software download, and a software modification and a post-check.

3. The method as claimed in claim 2, further comprising performing the pre-check and firmware modification on the network node based on the process, wherein the pre-check comprises:
performing an alarm check and a memory check until a plurality of commands is executed;
executing pre-check commands for maintaining a log in the pre-check; and
wherein the firmware modification comprises:
performing firmware download and firmware upgrade for the at least one network node.

4. The method as claimed in claim 2, wherein the software download comprises:
downloading the software for the network nodes based on the package version information and the release version information.

5. The method as claimed in claim 2, further comprising performing the software modification based on the process, wherein the software modification comprises one of software upgrade, software updating, a hotfix, and security update.

6. The method as claimed in claim 5, wherein performing the software modification and post-check comprising:
triggering the network nodes with software download success for a reboot timer change;
executing a plurality of commands for changing reboot timer parameters for the network nodes
modifying the software for the network nodes with respect to a provided package version and release version; and
performing rebooting of sites associated with the network nodes.

7. A system (100) for modifying a software of plurality of network nodes comprising:
a process engine (105) configured to determine a process for modifying the software of a network node;
a packaging unit (115) configured to generate a package comprising a set of instructions, package version information, release version information, program identities associated with the release version information, and a software modification schedule information;
the process engine (105) configured to communicate the process to a service engine (125); and
the service engine (125) configured to execute the package based on the process; and
the service engine (125) configured to modify schedule for at least one network node of the plurality of network nodes.

8. The system (100) claimed as in claim 7, wherein the process comprises a pre-check and firmware modification, software download, and software modification and post-check.

9. The system (100) claimed as in claim 8, wherein performing the pre-check and firmware modification on the network node based on the process, wherein for the pre-check, the process engine (105) configured to:
perform an alarm check and a memory check until a plurality of commands is executed;
execute pre-check commands for maintaining a log in the pre-check; and
perform firmware download and firmware upgrade for the at least one network node.

10. The system (100) claimed as in claim 8, wherein for the software download, the process engine (105) configured to:
download the software for the network nodes based on the package version information and the release version information.

11. The system (100) claimed as in claim 8 further comprising:
performing the software modification based on the process, wherein the software modification comprises one of software upgrade, software updating, a hotfix, and security update.

12. The system (100) claimed as in claim 11, wherein for performing the software modification and post-check, the process engine (105) configured to:
trigger the network nodes with software download success for a reboot timer change;
execute a plurality of commands for changing reboot timer parameters for the network nodes
modify the software for the network nodes with respect to a provided package version and release version; and
perform rebooting of sites associated with the network nodes.

13. A computer program product comprising a non-transitory computer-readable medium comprising instructions that, when executed by one or more processors, cause the one or more processors to perform a method for modifying a software of plurality of network nodes, the method comprising:
determining, by a process engine (105), a process for modifying the software of a network node;
generating, by a packaging unit (115), a package comprising a set of instructions, package version information, release version information, program identities associated with the release version information, and a software modification schedule information;
communicating, by the process engine (105), the process to a service engine (125);
executing, by the service engine (125), the package based on the process; and
modifying, by the service engine (125), schedule for at least one network node of the plurality of network nodes.
